(19) United States
(12) Patent Application Publication
(10) Pub. No.: US 2016/0285103 A1
(43) Pub. Date: Sep. 29, 2016

(54) POSITIVE ELECTRODE ACTIVE MATERIAL FOR LITHIUM ION SECONDARY BATTERY, POSITIVE ELECTRODE FOR LITHIUM ION SECONDARY BATTERY, AND LITHIUM ION SECONDARY BATTERY USING SAME

(71) Applicant: TDK CORPORATION, Tokyo (JP)

(72) Inventors: Junpei SHITABA, Tokyo (JP); Hideaki SEKI, Tokyo (JP); Akinobu NOJIMA, Tokyo (JP); Shin FUJITA, Tokyo (JP); Masahiro SAEGUSA, Tokyo (JP)

(73) Assignee: TDK CORPORATION, Tokyo (JP)

(21) Appl. No.: 15/077,151

(22) Filed: Mar. 22, 2016

(30) Foreign Application Priority Data
Mar. 27, 2015 (JP) 2015-066288
Feb. 3, 2016 (JP) 2016-018899

(51) Int. Cl. H01M 4/62; H01M 4/131; H01M 4/525; H01M 4/58; H01M 10/0525; H01M 4/36

(52) U.S. Cl. CPC H01M 4/628; H01M 10/0525; H01M 4/366; H01M 4/525; H01M 4/364; H01M 4/5825; H01M 4/131; H01M 2004/028

(57) ABSTRACT

A positive electrode active material for lithium ion secondary battery, includes: a lithium nickel complex oxide represented by composition formula (1); a phosphate compound; and a coating layer formed on at least a part of a surface of a particle of the lithium nickel complex oxide, and including a high thermal conductive material with heat conductivity of 500 W/m·K or more. The coating layer of the particle of the lithium nickel complex oxide includes a portion connected to the coating layer of another particle of the lithium nickel complex oxide:

LiₓNi_{1-y}M_{y}O₂ (1)

where M includes at least one metal selected from the group consisting of Co, Fe, Ti, Cr, Mg, Al, Cu, Ga, Mn, Zn, Sn, B, V, Ca, and Sr, and x and y are such that 0.05≦x≦1.2 and 0≦y≦0.5.

### CROSS-REFERENCE TO RELATED APPLICATION

This application claims priority from Japanese Patent Application No. 2015-066288 filed with the Japan Patent Office on Mar. 27, 2015, the entire content of which is hereby incorporated by reference.

### BACKGROUND

1. Technical Field

The present disclosure relates to positive electrode active material for lithium ion secondary battery, a positive electrode for lithium ion secondary battery, and a lithium ion secondary battery using the same.

2. Description of the Related Art

It is known that an increase in charge/discharge capacity can be achieved by using a lithium nickel complex oxide including Ni, Co, Mn; or Ni, Co, Al; or the like, compared with lithium cobaltate LiCoO₂, which is a representative existing active material for the lithium ion secondary battery. However, the thermal decomposition start temperature of the lithium nickel complex oxide is low compared with that of lithium cobaltate. In addition, in the lithium nickel complex oxide, Ni becomes quadrivalent at the time of charging, whereby the stability of the crystal structure is decreased. Accordingly, deterioration by cycling is large in lithium nickel complex oxide, and the problem is particularly found in high temperature environment.

In order to mitigate the instability of the lithium nickel complex oxide, a technique is known to mix a phosphate compound, such as LiFePO₄, with lithium nickel complex oxide.

JP-T-2014-510997 reports an improvement in output characteristics and battery capacity by uniformly coating the particles of lithium nickel complex oxide and phosphate compound with conductive material such as carbon. JP-A-2004-87299 reports an improvement in discharge capacity and thermal stability by coating the lithium nickel complex oxide with a phosphate compound. JP-A-2012-22888 reports a method for increasing energy density by coating an active material surface with carbon material or a compound of Al, Fe, and Mg and mixing with conductive fibers. JP-A-2013-84566 reports an improvement in safety and cycle characteristics by mixing vanadium phosphate coated by carbon with lithium nickel complex oxide.

However, JP-T-2014-510997, JP-A-2004-87299, and JP-A-2012-22888 do not suggest any improvement in cycle characteristics. According to the technique of JP-A-2013-84566, it is difficult to suppress deterioration of lithium nickel complex oxide sufficiently. Accordingly, a further improvement in cycle characteristics of lithium nickel complex oxide is desired.

### SUMMARY

A positive electrode active material for lithium ion secondary battery, includes: a lithium nickel complex oxide represented by composition formula (1); a phosphate compound; and a coating layer formed on at least a part of a surface of a particle of the lithium nickel complex oxide, and including a high thermal conductive material with heat conductivity of 500 W/m·K or more. The coating layer of the particle of the lithium nickel complex oxide includes a portion connected to the coating layer of another particle of the lithium nickel complex oxide:

LiₓNi_{1-y}M_{y}O₂ (1)

where M includes at least one metal selected from the group consisting of Co, Fe, Ti, Cr, Mg, Al, Cu, Ga, Mn, Zn, Sn, B, V, Ca, and Sr, and x and y are such that 0.05≦x≦1.2 and 0≦y≦0.5.

### BRIEF DESCRIPTION OF THE DRAWINGS

FIG. 1 is a schematic cross sectional view of a lithium ion secondary battery according to the present embodiment.

FIG. 2 is a schematic cross sectional view of a positive electrode active material for the lithium ion secondary battery according to the present embodiment;

FIG. 3 is a schematic view of flakes of high thermal conductive material according to the present embodiment; and

FIG. 4 is a schematic view of bars of high thermal conductive material according to the present embodiment.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a positive electrode active material for lithium ion secondary battery having high cycle characteristics, a positive electrode for lithium ion secondary battery, and a lithium ion secondary battery using the same.

A positive electrode active material for lithium ion secondary battery (the present positive electrode active material) according to one aspect of the present disclosure, includes: a lithium nickel complex oxide represented by composition formula (1); a phosphate compound; and a coating layer formed on at least a part of a surface of a particle of the lithium nickel complex oxide, and including a high thermal conductive material with heat conductivity of 500 W/m·K or more. The coating layer of the particle of the lithium nickel complex oxide includes a portion connected to the coating layer of another particle of the lithium nickel complex oxide:

LiₓNi_{1-y}M_{y}O₂ (1)

where M includes at least one metal selected from the group consisting of Co, Fe, Ti, Cr, Mg, Al, Cu, Ga, Mn, Zn, Sn, B, V, Ca, and Sr, and x and y are such that 0.05≦x≦1.2 and 0≦y≦0.5.

By using the present positive electrode active material, a lithium ion secondary battery with improved cycle characteristics can be provided. This effect is believed to be due to the following. The coating layer formed on the particle surface of the lithium nickel complex oxide and including high thermal conductive material efficiently conducts the Joule heat and reaction heat generated during charging and discharging, whereby a temperature increase of the active material particle is suppressed. As a result, deterioration of the lithium nickel complex oxide crystal structure is suppressed.

Incidentally, in the present positive electrode active material, the coating layer of the particle of the lithium nickel complex oxide may include a portion (first portion) directly connected to the coating layer of the other particle of the lithium nickel complex oxide.

Alternatively, in the present positive electrode active material, the coating layer of the particle of the lithium nickel complex oxide may include a portion (second portion) connected to the coating layer of the other particle of the lithium nickel complex oxide via flakes or bars of high thermal conductive material with heat conductivity of 500 W/m·K or more.

That is, the portion of the coating layer of the particle of the lithium nickel complex oxide that is connected to the coating layer of the other particle of the lithium nickel complex oxide may be a portion (first portion) directly connected to (directly contacting) the coating layer of the other particle of the lithium nickel complex oxide, or a portion (second portion) connected to the coating layer of the other particle of the lithium nickel complex oxide via (indirectly) flakes or bars of high thermal conductive material with heat conductivity of 500 W/m·K or more.

In the present positive electrode active material, the coating layer of the particle of the lithium nickel complex oxide may include both the portion directly connected to the coating layer of the other particle of the lithium nickel complex oxide and the portion connected to the coating layer of the other particle of the lithium nickel complex oxide via flakes or bars of high thermal conductive material with heat conductivity of 500 W/m·K or more.

In this configuration, a lithium ion secondary battery with enhanced cycle characteristics can be provided. This effect is believed due to the following. A thermal conduction network is formed by the coating layer, which is formed on the particle surface of lithium nickel complex oxide and includes high thermal conductive material, and by the flakes or bars of high thermal conductive material connecting the active material particles. As a result, the Joule heat and reaction heat generated during charging/discharging are efficiently conducted, whereby a temperature increase of the active material particle is suppressed. As a result, deterioration of the crystal structure of lithium nickel complex oxide is suppressed.

In the present positive electrode active material, the ratio of the phosphate compound to a total mass of the positive electrode active material for lithium ion secondary battery may be 1 mass % to 40 mass %. In this configuration, the phosphate compound ratio being in the range ensures thermal stability of the lithium nickel complex oxide. As a result, cycle characteristics are improved while an energy density decrease in the positive electrode due to the phosphate compound can be suppressed.

In the present positive electrode active material, the coating layer may have an average thickness of 10 nm to 500 nm. In this configuration, an increase in thermal conduction can be achieved. In addition, blocking of Li ion diffusion by the coating layer can be decreased. As a result, good rate characteristics can be obtained while an energy density decrease in the positive electrode can be suppressed.

In the present positive electrode active material, the high thermal conductive material in the coating layer may include graphene or multi-layer graphene. The flakes or bars of high thermal conductive material may also include graphene or multi-layer graphene. Because graphene and multi-layer graphene have very high heat conductivity and electrical conductivity, cycle characteristics can be even more improved.

The flakes of high thermal conductive material may be flakes of the multi-layer graphene.

In this case, the flakes of multi-layer graphene may have an average thickness of 3 nm to 100 nm. It is believed that when the average thickness of the multi-layer graphene is in this range, a thermal conduction route can be more effectively ensured, whereby thermal conduction by the thermal conduction network is increased.

The phosphate compound may be a compound represented by composition formula (2), composition formula (3), or composition formula (4). The compounds represented by composition formula (2) and composition formula (3) have high charging/discharging voltage and discharge capacity. Accordingly, an increase in energy density is achieved.

Li₃V₂(PO₄)₃ (2)

LiNPO₄ (3)

LiₓNPO₄ (4)

where N is at least one selected from the group consisting of Mn, Co, Ni, Fe, and VO, and x is a value such that 1<x≦1.5.

The phosphate compound may be lithium vanadium phosphate represented by LiVOPO₄ or Li₃V₂(PO₄)₃.

The lithium nickel complex oxide may be lithium nickel complex oxide represented by composition formula (5):

LiₓNi_{1-y-z}Co_{y}Al_{z}O₂ (5)

where x, y, and z are such that 0.05≦x≦1.2, 0<y<0.5, and 0<z<0.5.

The lithium nickel complex oxide has high crystal structure stability and energy density. Thus, cycle characteristics and energy density can be even more improved.

As described above, the present positive electrode active material has excellent cycle characteristics. Accordingly, the present positive electrode active material can be applied in the positive electrode for lithium ion secondary battery, and in lithium ion secondary batteries.

According to one aspect of the present disclosure, there are provided a positive electrode active material for lithium ion secondary battery having high cycle characteristics, a positive electrode for lithium ion secondary battery, and a lithium ion secondary battery using the same.

An example of a preferred embodiment of the lithium ion secondary battery according to the present disclosure will be described with reference to the drawings. It should be noted, however, that the lithium ion secondary battery according to the present disclosure is not limited to the following embodiments. The dimensional ratios of the drawings are not limited to the illustrated ratios.

### Lithium Ion Secondary Battery

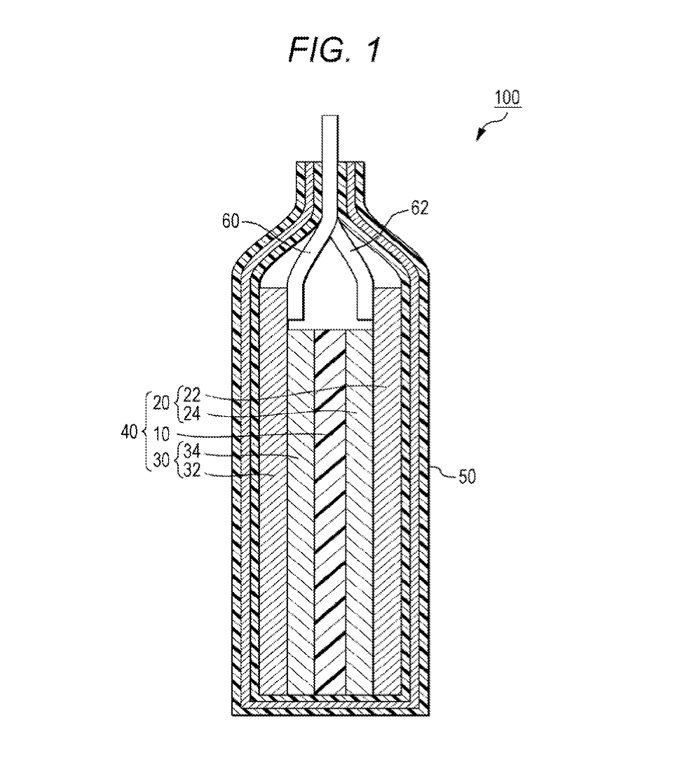

The electrodes and the lithium ion secondary battery according to the present embodiment will be briefly described with reference to FIG. 1. The lithium ion secondary battery 100 is mainly provided with a stacked body 40, a case 50 housing the stacked body 40 in a sealed state, and a pair of leads 60, 62 connected to the stacked body 40. While not shown in the drawings, an electrolyte is also housed in the case 50 along with the stacked body 40.

In the stacked body 40, a positive electrode 20 and a negative electrode 30 are disposed opposite each other across a separator 10. The positive electrode 20 includes a plate-like (film) positive electrode current collector 22, and a positive electrode active material layer 24 disposed on the positive electrode current collector 22. The negative electrode 30 includes a plate-like (film) negative electrode current collector 32 and a negative electrode active material layer 34 disposed on the negative electrode current collector 32. The positive electrode active material layer 24 and the negative electrode active material layer 34 are in contact with corresponding sides of the separator 10. To corresponding edge parts of the positive electrode current collector 22 and the negative electrode current collector 32, leads 62, 60 are connected. Edge parts of the leads 60, 62 are disposed outside the case 50.

Hereafter, the positive electrode 20 and the negative electrode 30 may be collectively referred to as the electrode 20, 30. The positive electrode current collector 22 and the negative electrode current collector 32 may be collectively referred to as the current collector 22, 32. The positive electrode active material layer 24 and the negative electrode active material layer 34 may be collectively referred to as the active material layer 24, 34.

### Positive Electrode Active Material

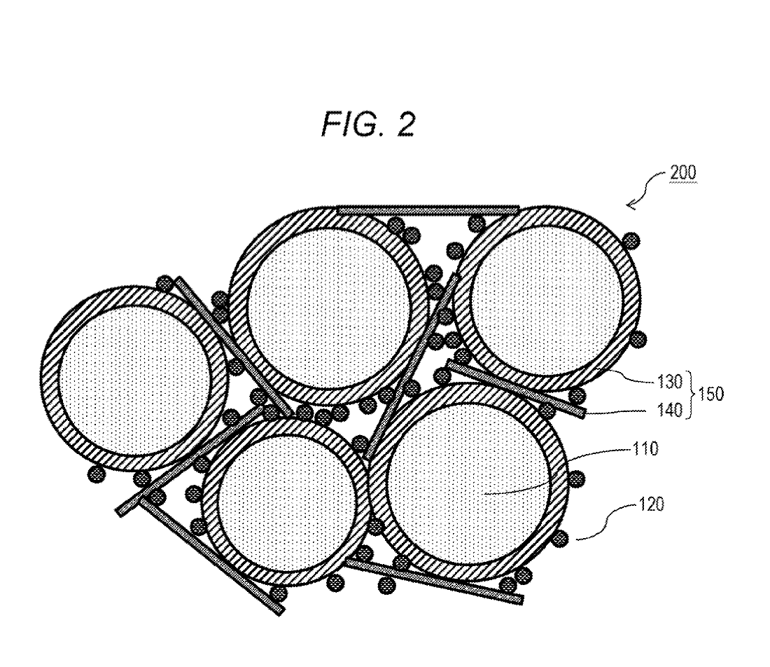

A positive electrode active material 200 according to the present embodiment will be described with reference to FIGS. 2, 3, and 4. According to the present embodiment, the positive electrode active material 200 includes a lithium nickel complex oxide 110 represented by a composition formula (1) indicated below, and a phosphate compound 120, as illustrated in FIG. 2. In at least a part of the particle surface of the lithium nickel complex oxide 110, a coating layer 130 including high thermal conductive material with heat conductivity of 500 W/m·K or higher is formed. In addition, through flakes or bars of high thermal conductive material 140, at least some of the coating layers 130 are mutually connected. In this way, a thermal conduction network 150 is formed. Obviously, while not illustrated in the drawings, the coating layers 130 may be directly connected to one another. In this way, too, the thermal conduction network 150 can be formed.

LiₓNi_{1-y}M_{y}O₂ (1)

The coating layers 130 illustrated in FIG. 2 may have portions directly contacting the coating layers 130 with one another (directly connected portion), and portions connecting the coating layers 130 via the flakes or bars of high thermal conductive material 140 having heat conductivity of 500 W/m·K or higher. This state is believed to enable the Joule heat and reaction heat generated during charging/discharging to be more efficiently conducted, suppressing an increase in the temperature of the active material particles. In this way, deterioration of the crystal structure of the lithium nickel complex oxide 110 is mitigated. As a result, the cycle characteristics of the positive electrode active material 200 can be improved.

### Lithium Nickel Complex Oxide

According to the present embodiment, the lithium nickel complex oxide 110 is a complex oxide represented by the following composition formula (1):

LiₓNi_{1-y}M_{y}O_{z} (1)

where M includes at least one metal selected from the group consisting of Co, Fe, Ti, Cr, Mg, Al, Cu, Ga, Mn, Zn, Sn, B, V, Ca, and Sr, and x and y are such that 0.05≦x≦1.2, and 0≦y≦0.5.

The complex oxide represented by composition formula (1) may not necessarily have the amount of oxygen of the stoichiometric composition expressed by the composition formula, and may have a wide range including oxygen deficiency. That is, the range of the complex oxide represented by composition formula (1) may be identified as being the identical composition system by, for example, X-ray diffraction.

More specifically, the complex oxide represented by composition formula (1) may be a ternary nickel cobalt aluminum (NCA) material, such as Li_{0.1}Ni_{0.83}Co_{0.14}Al_{0.03}O_{2.0} or Li_{1.0}Ni_{0.8}Co_{0.15}Al_{0.05}O_{2.0}, or a ternary nickel cobalt manganese (NCM) material, such as Li_{1.0}Ni_{0.8}Co_{0.1}Mn_{0.1}O_{2.0}. Among others, NCA may be preferable as it has higher energy density.

The lithium nickel complex oxide 110 may have an average particle diameter of 1 μm to 50 μm. When the average particle diameter is 1 μm or greater, the amount of the high thermal conductive material 140 for forming the coating layer 130 on the particle surfaces of the lithium nickel complex oxide 110 is reduced, whereby the ratio of the lithium nickel complex oxide 110 is increased. As a result, an increase in energy density can be achieved. When the average particle diameter is 50 μm or smaller, conduction of electrons, Li ions, and heat from inside the particles of the lithium nickel complex oxide 110 to the outside is increased. As a result, the cycle characteristics and energy density of the positive electrode can be improved.

It goes without saying that the lithium nickel complex oxide 110 according to the present embodiment may include a mixture of the above-described two types and other lithium nickel complex oxide.

The type of the lithium nickel complex oxide 110, the phosphate compound 120, and the high thermal conductive material included in the positive electrode active material 200 according to the present embodiment can be identified by X-ray diffraction, X-ray photoelectron spectroscopy, or energy dispersive X-ray spectrometry analysis, for example. Among others, X-ray diffraction may be preferable. The mixing ratios may be identified by inductively coupled plasma optical emission spectrometry, for example.

### Phosphate Compound

The phosphate compound 120 according to the present embodiment may include, specifically, compounds represented by composition formula (2), composition formula (3), or composition formula (4). Among others, lithium vanadium phosphate represented by LiVOPO₄ or Li₃V₂(PO₄)₃ may be preferable as they have high energy density and do not readily elute transition metal. Note, however, that the phosphate compound is not limited to the stoichiometric composition, and may include an excess-Li phosphate compound represented by composition formula 4, for example:

Li₃V₂(PO₄)₃ (2)

LiNPO₄ (3)

LiₓNPO₄ (4)

where N is at least one selected from the group consisting of Mn, Co, Ni, Fe, and VO, and x is a value such that 1<x≦1.5.

The phosphate compound represented by composition formula (2), (3), or (4) may not necessarily have the amount of oxygen of the stoichiometric composition expressed by the composition formula, and may include a wide range including oxygen deficiency. Specifically, the range of the phosphate compound composition represented by formula (2), (3), or (4) may be identified as being the identical composition system by X-ray diffraction, for example.

Accordingly, the phosphate compound 120 according to the present embodiment includes, in addition to the phosphate compound represented by composition formulas (2), (3), or (4), phosphate compounds represented by the composition formulas in which one or more of the transition metal elements are substituted by one or more elements selected from the group consisting of W, Mo, Ti, Al, Ni, Co, Mn, Fe, Zr, Cu, Zn, and Yb.

The phosphate compound 120 according to the present embodiment may include one or more lithium vanadium phosphates.

The lithium vanadium phosphate may be represented by LiVOPO₄ or Li₃V₂ (PO₄)₃.

### High Thermal Conductive Material

As the high thermal conductive material in the coating layers 130, there may be used graphene, multi-layer graphene, boron nitride, carbon nanotube, or the like. Among others, graphene and multi-layer graphene may be preferable as they have very high thermal conduction and electrical conduction. The coating layer may contain the high thermal conductive material as a principal component and may also include other material. The content of the high thermal conductive material as principal component may be 60% or more, 80% or more, or 90% or more.

Graphene is a monoatomic layer substance with a structure of six-membered rings of carbon atoms densely laid on a plane. The multi-layer graphene refers to substance with a structure of a plurality of stacked layers of graphene, with a thickness of not more than 100 nm.

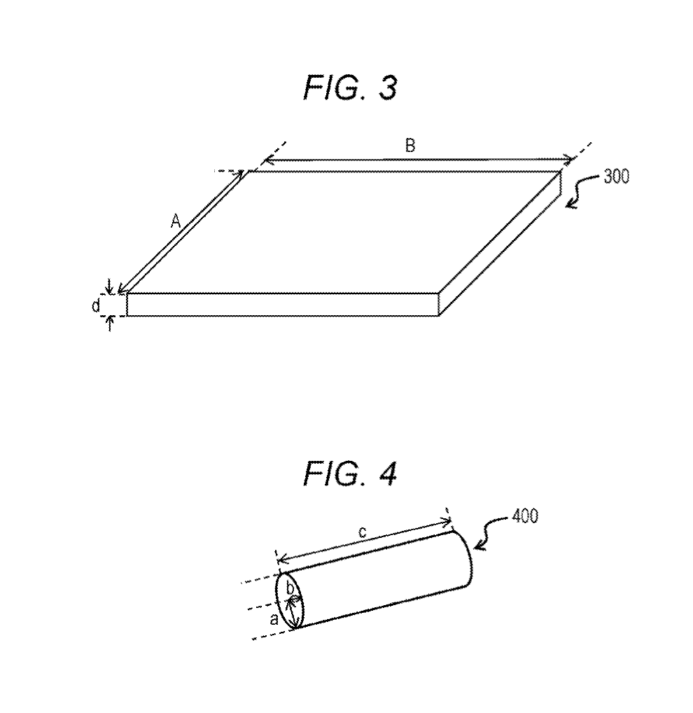

The flakes of the high thermal conductive material 140 may have a flat particle 300 shape, as illustrated in FIG. 3. In this case, the thickness d and an average length of long side B and short side A may have an aspect ratio of 10 or more. The long side and the short side may have an average length of 2 μm to 50 μm.

The bars of high thermal conductive material 140 may have a bar particle 400 shape, as illustrated in FIG. 4. In this case, an average radius of major radius a and minor radius b and length c may have an aspect ratio of 10 or more. The length c may be 2 μm to 50 μm.

As the flakes or bars of high thermal conductive material 140, there may be used graphene, multi-layer graphene, boron nitride, carbon nanotube, or the like. Among others, graphene and multi-layer graphene may be preferable as they have very high thermal conduction and electrical conduction.

The high thermal conductive material in the coating layer 130 and the flakes or bars of high thermal conductive material 140 may be the same material or different materials. The flakes of high thermal conductive material conduct heat and electrons in two-dimensional directions in a plane. Thus, the thermal conduction material that contributes to conduction is decreased. When flakes of high thermal conductive material are used in the high thermal conductive material of the coating layer 130 and in the high thermal conductive material 140, thermal conduction efficiency is increased, whereby the cycle characteristics are improved.

According to the present embodiment, the ratio of the phosphate compound 120 to the total mass of the positive electrode active material 200 may be 1 mass % to 40 mass %. In this range, the thermal stability of the lithium nickel complex oxide 110 is increased. Further, by mixing the phosphate compound 120, the high energy density of the positive electrode 20 can be maintained. The ratio of the phosphate compound 120 to the total mass of the positive electrode active material 200 may be 5 mass % to 20 mass %. In this range, particularly high cycle characteristics and energy density can be obtained.

According to the present embodiment, the ratio of the phosphate compound 120 to the total mass of the positive electrode active material 200 may be measured by X-ray diffraction, X-ray photoelectron spectroscopy, or energy dispersive X-ray spectrometry analysis, for example. Particularly, after the type of the phosphate compound 120 is identified by X-ray diffraction, the ratio of the phosphate compound 120 to the total mass of the positive electrode active material 200 may be measured by inductively coupled plasma optical emission spectrometry.

The coating layer 130 on the particle surface of the lithium nickel complex oxide 110 may have an average thickness of 10 nm to 500 nm. When the coating layer 130 has an average thickness of 10 nm or more, the surface of the lithium nickel complex oxide 110 can be uniformly covered. As a result, cycle characteristics are improved. In addition, by making the average thickness of the coating layer 130 500 nm or less, a decrease in energy density can be suppressed.

The coating layer 130 on the particle surfaces of the lithium nickel complex oxide 110 may have an average thickness of 100 nm to 200 nm. When the coating layer 130 has the average thickness of 100 nm or more, the cross sectional area of the conduction path is increased, whereby the thermal conduction of the thermal conduction network 150 is increased. The heat and electrical conduction in a plane-to-plane direction of the multi-layer graphene is inferior to the heat and electrical conduction in an in-plane direction. When the coating layer 130 has the average thickness of 200 nm or less, the conduction path in the plane-to-plane direction of the thermal conduction network 150 becomes shorter. As a result, the thermal conduction of the thermal conduction network 150 is increased, whereby cycle characteristics are improved. As a result, an increase in Li ion diffusion speed is obtained, and rate characteristics are improved.

The coating layer 130 according to the present embodiment is not particularly limited as long as it provides the effects of the technology of the present disclosure. The coating layer 130 may coat 75% or more of the particle surface of the lithium nickel complex oxide 110. In this range, a good thermal conduction network 150 can be formed.

The flakes or bars of high thermal conductive material 140 connecting the coating layers 130 may have an average thickness of 3 nm to 100 nm. In this range, the thermal conduction route can be shortened while ensuring sufficient cross sectional area for thermal conduction. In this way, improved cycle characteristics can be obtained. The average thickness of the flakes or bars of high thermal conductive material 140 connecting the coating layers 130 may be 5 nm to 40 nm. In this range, the flakes or bars of high thermal conductive material 140 can be provided with adequate flexibility, whereby bending of the high thermal conductive material 140 can be suppressed. In this way, increased adhesion can be obtained between the high thermal conductive material 140 and the lithium nickel complex oxide 110 (the coating layers 130). As a result, further improved cycle characteristics can be obtained.

The type of the lithium nickel complex oxide 110, the phosphate compound 120, and the high thermal conductive material included in the positive electrode active material 200 according to the present embodiment can be identified by X-ray diffraction, X-ray photoelectron spectroscopy, or energy dispersive X-ray spectrometry analysis, for example. Among others, X-ray diffraction may be preferable. The mixing ratios may be identified by inductively coupled plasma optical emission spectrometry, for example.

After cutting the positive electrode 20 and then polishing the section using a cross section polisher or an ion milling device and the like, a scanning electronic microscope, a transmission electron microscope, or the like may be used to measure the average thickness and the coating state of the coating layers 130 including the high thermal conductive material on the particle surface of the lithium nickel complex oxide 110 according to the present embodiment, as well as the average thickness of the flakes or bars of high thermal conductive material 140. Particularly, the transmission electron microscope may preferably be used.

The average thickness of the coating layer 130 including the high thermal conductive material on the particle surface of the lithium nickel complex oxide 110 according to the present embodiment may be measured as follows. For example, using a transmission electron microscope, cross sections of 20 particles of the lithium nickel complex oxide 110 are observed, and the thicknesses of the coating layers 130 of the particles is measured. Then, an average value of the thicknesses of the coating layers 130 of the 20 particles is considered the average thickness of the coating layers 130. Further, averages of thickness d, the lengths of short side A and long side B, major radius a, minor radius b, and length c of flakes or bars of high thermal conductive material 140 can be measured as follows. The cross sections of 20 flakes or bars of high thermal conductive material 140 connecting the particles are observed and the various values are measured, and their average values are obtained.

When the high thermal conductive material includes substance with high electrical conductivity, such as graphene or CNT, high rate characteristics can be obtained without adding a conductive auxiliary agent. Nevertheless, trace amounts of carbon material with small particle diameter, such as carbon black, acetylene black, or Ketjen black, may be added during the preparation of a high thermal conductive material paint. In this way, further improvements in rate characteristics and cycle characteristics can be achieved. This is believed due to enhancement of heat and electrical conduction at the points of contact of the high thermal conductive material by the small particle diameter carbon.

### Positive Electrode Current Collector

The positive electrode current collector 22 may be a plate of conductive material. For example, as the positive electrode current collector 22, a metal thin plate with an aluminum, copper, or nickel foil may be used.

### Positive Electrode Binder

The binder binds the active materials and also binds the active materials with the current collector 22. The binder may be any binder capable of achieving the above binding. Examples of the binder include fluorine resin such as polyvinylidene fluoride (PVDF), polytetrafluoroethylene (PTFE), tetrafluoroethylene/hexafluoropropylene copolymer (FEP), tetrafluoroethylene/perfluoro alkyl vinyl ether copolymer (PFA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF).

Other than the above examples, vinylidene fluoride fluorine rubber may be used as the binder. Examples of fluorine rubber based on vinylidene fluoride include fluorine rubber based on vinylidene fluoride/hexafluoropropylene (VDF/HFP-based fluorine rubber), fluorine rubber based on vinylidene fluoride/hexafluoropropylene/tetrafluoroethylene (VDF/HFPTFE-based fluorine rubber), fluorine rubber based on vinylidene fluoride/pentafluoropropylene (VDF/PFP-based fluorine rubber), fluorine rubber based on vinylidene fluoride/pentafluoropropylene/tetrafluoroethylene (VDF/PFP/TFE-based fluorine rubber), fluorine rubber based on vinylidene fluoride/perfluoromethyl vinyl ether/tetrafluoroethylene (VDF/PFMVE/TFE-based fluorine rubber), and fluorine rubber based on vinylidene fluoride/chlorotrifluoroethylene (VDF/CTFE-based fluorine rubber).

As the binder, a conductive polymer having electronic conductivity or conductive polymer having ion conductivity may be used. An example of the conductive polymer having electronic conductivity is polyacetylene. In this case, the binder will also serve as conductive material, so that other conductive material may not be added. An example of the conductive polymer having ion conductivity is a composite of polymer compound, such as polyethylene oxide or polypropylene oxide, and a lithium salt or an alkali metal salt based on lithium.

### Negative Electrode Active Material

The negative electrode active material may be a compound capable of lithium ion intercalation and deintercalation. As the negative electrode active material, known negative electrode active material for lithium-ion batteries may be used. As the negative electrode active material, substance capable of lithium ion intercalation and deintercalation may be used. Examples of such substance include carbon material such as graphite (natural graphite and synthetic graphite), carbon nanotube, hard carbon, soft carbon, and low temperature heat-treated carbon; metals that can be combined with lithium, such as aluminum, silicon, and tin; amorphous compound based on an oxide such as silicon dioxide and tin dioxide; and particles including lithium titanate (Li₄Ti₅O₁₂) or the like. The negative electrode active material may be graphite, which has high capacity per unit weight and is relatively stable.

### Negative Electrode Current Collector

The negative electrode current collector 32 may be a plate of conductive material. As the negative electrode current collector 32, a metal thin plate including aluminum, copper, or nickel foil may be used.

### Negative Electrode Conductive Material

Examples of the conductive material include carbon material such as carbon powder of carbon black and the like, and carbon nanotube; metal fine powder of copper, nickel, stainless, or iron; a mixture of carbon material and metal fine powder, and conductive oxide such as ITO.

### Negative Electrode Binder

As the binder used in the negative electrode, materials similar to those for the positive electrode may be used.

### Separator

The material of the separator 10 may have an electrically insulating porous structure. Examples of the material include a single-layer body or stacked body of polyethylene, polypropylene, or polyolefin film; extended film of a mixture of the aforementioned resins; and fibrous nonwoven fabric including at least one constituent material selected from the group consisting of cellulose, polyester, and polypropylene.

### Non-Aqueous Electrolyte

The non-aqueous electrolyte includes electrolyte dissolved in non-aqueous solvent. The non-aqueous solvent may contain cyclic carbonate and chain carbonate.

The cyclic carbonate is not particularly limited as long as it is capable of solvating the electrolyte, and known cyclic carbonate may be used. Examples of the cyclic carbonate include ethylene carbonate, propylene carbonate, and butylene carbonate.

The chain carbonate is not particularly limited as long as it is capable of decreasing the viscosity of the cyclic carbonate, and known chain carbonate may be used. Examples of the chain carbonate include diethyl carbonate, dimethyl carbonate, and ethyl methyl carbonate. As the chain carbonate, there may be used a mixture of methyl acetate, ethyl acetate, methyl propionate, ethyl propionate, γ-butyrolactone, 1,2-dimethoxyethane, 1,2-diethoxyethane, and the like.

The ratio of the cyclic carbonate and the chain carbonate in the non-aqueous solvent may be 1:9 to 1:1 by volume.

Examples of the electrolyte include lithium salts such as LiPF₆, LiClO₄, LiBF₄, LiCF₃SO₃, LiCF₃, CF₂SO₃, LiC(CF₃SO₂), LiN(CF₃SO₂)₂, LiN(CF₃CF₂SO₂)₂, LiN(CF₃SO₂)(C₄FSO₂), LiN(CF₃CF₂CO)₂, and LiBOB. Any of the lithium salts may be used individually, or two or more lithium salts may be used in combination. Particularly, from the viewpoint of electrical conductivity, the electrolyte may preferably include LiPF₆.

When LiPF₆ is dissolved in non-aqueous solvent, the concentration of the electrolyte in the non-aqueous electrolyte may be adjusted to 0.5 to 2.0 mol/L. When the electrolyte concentration is 0.5 mol/L or more, sufficient conductivity of the non-aqueous electrolyte can be ensured. As a result, sufficient capacity can be more readily obtained during charging/discharging. Further, by limiting the electrolyte concentration to 2.0 mol/L or less, an increase in the viscosity of the non-aqueous electrolyte can be suppressed, and sufficient lithium ion mobility can be ensured. As a result, sufficient capacity can be more readily obtained during charging/discharging.

When LiPF₆ is mixed with other electrolytes, the lithium ion concentration in the non-aqueous electrolyte may be adjusted to 0.5 to 2.0 mol/L. Of the lithium ions in the non-aqueous electrolyte, the lithium ions from LiPF₆ may have a concentration of 50 mol % or more.

### Method for Manufacturing Positive Electrode Active Material

The positive electrode active material 200 according to the present embodiment may be manufactured by the following coating step and mixing step.

### Coating Step

In the coating step, the high thermal conductive material is coated on a surface of the lithium nickel complex oxide 110, whereby the coating layer 130 is formed. The method for forming the coating layer 130 is not particularly limited, and a conventional method may be used to form the coating layer 130 on the particle surface. Examples of the method include mechanochemical methods using mechanical energy, such as friction and compression, and a spray dry method of spraying coating liquid onto the particles. Among others, the mechanochemical method may be preferable as it enables formation of uniform coating layers 130 with good adhesion.

Specific examples of the manufacturing devices for the mechanochemical method include devices such as a Mechanofusion device and a planetary mill. A specific example of the device for the spray dry method is a spray drier.

The adhesion between the coating layers 130 including graphene or multi-layer graphene and the active material particles, and the crystallinity of the graphene or multi-layer graphene in the coating layers 130 can be adjusted by varying the coating layer 130 forming conditions. For example, when the coating layers 130 are formed by mechanochemical method, the adhesion and crystallinity of the coating layers 130 can be adjusted by appropriately adjusting the angle and rotational speed of the processing device, processing time, or material input.

### Mixing Step

In the mixing step, the lithium nickel complex oxide 110 obtained in the coating step with the coating layers 130 formed on the surface thereof, the phosphate compound 120, and the flakes or bars of high thermal conductive material 140 are mixed. In this way, the positive electrode active material is obtained.

According to the present embodiment, the mixing step is not particularly limited, and may employ a conventional device such as a Turbula mixer or a Henschel mixer.

### Method for Manufacturing Electrodes 20, 30

A method for manufacturing the electrode 20 and 30 according to the present embodiment will be described.

The active material, binder, and solvent are mixed to prepare a paint. If necessary, conductive material may be further added. As the solvent, water or N-methyl-2-pyrrolidone may be used. The method of mixing the components of the paint is not particularly limited. The order of mixing is also not particularly limited. The paint is coated onto the current collectors 22 and 32. The coating method is not particularly limited, and a method typically adopted for electrode fabrication may be used. The coating method may include slit die coating and doctor blade method.

Thereafter, the solvent in the paint coating the current collectors 22 and 32 is removed. The removing method is not particularly limited, and may include drying the current collectors 22 and 32 with the paint coat thereon in an atmosphere of 80° C. to 150° C.

The resulting electrodes with the positive electrode active material layer 24 and the negative electrode active material layer 34 respectively formed thereon are pressed by a roll press device or the like as needed. The roll press may have a linear load of 1000 kgf/cm, for example.

Through the above-described steps, there are obtained the positive electrode 20 including the positive electrode current collector 22 with the positive electrode active material layer 24 formed thereon, and the negative electrode 30 including the negative electrode current collector 32 with the negative electrode active material layer 34 formed thereon.

### Method for Manufacturing Lithium Ion Secondary Battery

In the following, a method for manufacturing the lithium ion secondary battery 100 according to the present embodiment will be described. The method for manufacturing the lithium ion secondary battery 100 according to the present embodiment includes a step of sealing, in the case (exterior body) 50, the positive electrode 20 and the negative electrode 30 including the above-described active materials, the separator 10 to be disposed between the positive electrode 20 and the negative electrode 30, and the nonaqueous electrolytic solution including lithium salt.

For example, the positive electrode 20 and the negative electrode 30 including the above-described active materials, and the separator 10 are stacked. The positive electrode 20 and the negative electrode 30 are heated and pressed from a direction perpendicular to the stacked direction, using a pressing tool. In this way, the stacked body 40 including the positive electrode 20, the separator 10, and the negative electrode 30 that are mutually closely attached is obtained. The stacked body 40 is then put into a pre-fabricated bag of the case 50, for example, and additionally the nonaqueous electrolytic solution including the above-described lithium salt is injected. In this way, the lithium ion secondary battery 100 is fabricated. Instead of injecting the nonaqueous electrolytic solution including the lithium salt into the case 50, the stacked body 40 may be impregnated in advance in a nonaqueous electrolytic solution including the lithium salt.

It should be noted, however, that the present disclosure is not limited to the embodiment, and that the embodiment is merely illustrative. Any and all configurations that are substantially identical, either in operation or effect, to the technical concept set forth in the claims are included in the technical scope of the present disclosure.

### EXAMPLES

### Example 1

### Preparation of Positive Electrode

The lithium nickel complex oxide of Li_{1.0}Ni_{0.83}Co_{0.14}Al_{0.03}O_{2.0} (hereafter referred to as NCA) with an average particle diameter of 15 μm, and graphene with an average thickness of 8 nm and an average length of major radius and minor radius of 15 μm were weighed to the mass ratio of 100:1.4. The weighed NCA and graphene were processed using a Hosokawa Micron Mechanofusion system inclined at 5° and at a rotational speed of 3500 rpm. In this way, a graphene coating layer was formed on a surface of NCA. The phosphate compound of LiVOPO₄ was weighed at a mass ratio of 95:5 to the NCA with the coating layer. Further, plates of graphene with an average thickness of 8 nm and an average length of major radius and minor radius of 15 μm were weighed at the mass ratio of 100:0.6 to the NCA with the coating layer. The NCA with the coating layer, LiVOPO₄, and the plates of graphene were mixed using a Henschel mixer, whereby positive electrode active material (positive electrode active material powder) was obtained. 97.5% of the positive electrode active material powder and 2.5% of polyvinylidene fluoride (PVDF) were dispersed in N-methyl-2-pyrrolidone (NMP), preparing a slurry. The obtained slurry was coated on an aluminum foil with a thickness of 15 μm. The aluminum foil with the slurry coated thereon was dried at a temperature of 120° for 30 minutes, and then pressed using a roll press device at a linear load of 1000 kgf/cm. In this way, the positive electrode was obtained.

### Measurement of High Thermal Conductive Material

The heat conductivity of the graphene used as the high thermal conductive material was measured using an optical AC device.

### Measurement of High Thermal Conductive Material in Positive Electrode

The state of the graphene-including coating layer in the lithium nickel complex oxide particle surface was measured using a transmission electron microscope (TEM), a scanning electronic microscope (SEM), a Raman spectroscopy device, a cross section polisher, and an ion milling device. Measurement samples were fabricated by cutting the positive electrode and polishing the cross section using the cross section polisher and the ion milling device.

Through observation of the positive electrode surface and the positive electrode cross section by SEM, EDX, and TEM, it was confirmed that a uniform graphene coating layer was formed on the lithium nickel complex oxide particle surface. It was also learned that the coating layer had an average thickness of 140 nm. The presence of the plates of graphene in contact with the coating layer was confirmed. The plates of graphene had an average thickness of 8 nm.

By Raman mapping measurement of the positive electrode cross section using the Raman spectroscopy device, formation of a graphene-including coating layer on the lithium nickel complex oxide particle surface was confirmed.

### Fabrication of Negative Electrode

A slurry was prepared by dispersing 90 parts by mass of natural graphite powder as the negative electrode active material and 10 parts by mass of PVDF in NMP. The slurry was coated on a copper foil with a thickness of 15 μm. The copper foil with the slurry coated thereon was dried under reduced pressure at a temperature of 140° C. for 30 minutes, and then pressed using a roll press device. In this way, the negative electrode was obtained.

### Nonaqueous Electrolytic Solution

In a mixture solvent of ethylene carbonate (EC) and diethyl carbonate (DEC), LiPF₆ was dissolved to 1.0 mol/L, and further LiBF₄ was dissolved to 0.1 mo/L, whereby a nonaqueous electrolytic solution was obtained. In the mixture solvent, the volume ratio of EC and DEC was EC:DEC=30:70.

### Separator

A microporous polyethylene film (pore ratio: 40%, shut down temperature: 134° C.) with a film thickness of 20 μm was prepared.

### Battery Fabrication

A power generating element was constructed by stacking the positive electrode, the negative electrode, and the separator. The power generating element and the non-aqueous electrolyte were used to fabricate a battery cell according to Example 1.

### C Rate

The current density such that the battery cell capacity is charged or discharged in an hour is referred to as 1 C. In the following, the current density at the time of charging or discharging will be expressed using constant multiples of the C rate (For example, the current density of one half of 1 C will be expressed as 0.5 C).

### Measurement of Rate Characteristics

Using the fabricated battery cell of Example 1, constant current charging was performed at the current density of 0.1 C until voltage reached 4.2 V (vs. Li/Li⁺). Further, constant voltage charging was performed at 4.2 V (vs. Li/Li⁺) until the current density decreased to 0.05 C, when the charge capacity was measured.

After a pause of 5 minutes, constant current discharging was performed at the current density of 0.1 C until voltage reached 2.5 V (vs. Li/Li⁺), when the discharge capacity was measured. The current density was calculated assuming that 1 C corresponded to 186 mAh/g per weight of the positive electrode active material.

The rate characteristics of the battery cell was measured by repeating the charging/discharging procedure at the charging/discharging current density of 1 C.

### Measurement of Cycle Characteristics

The battery cell after the rate measurement was subjected to 100 cycles of the charging/discharging procedure at 0.5 C charge/1 C discharge. The charging and discharging were performed in a constant temperature bath at 45° C.

### Examples 2 to 4 and Comparative Examples 1 and 2

In Examples 2 to 4 and Comparative Examples 1 and 2, battery cells were fabricated in the same way as in Example 1 while modifying the type of the high thermal conductive material, the coating layer, and the presence or absence of the flakes or bars of substance. The battery cells of Examples 1 to 4 and Comparative Examples 1 and 2 were evaluated. The results are shown in Table 1.

TABLE 1

| | | | | (3) | (4) | |
|---|---|---|---|---|---|---|
| | | | | Coating | Flakes/bars | |
| | | | | layer high | of high | Thermal |
| | | (2) | | thermal | thermal | conductivity |
| | (1) | Phosphate | Ratio | conducting | conducting | (3), (4) |
| | Lithium-nickel complex oxide | compound | (1):(2) | material | material | [W/m · K] |
| Example 1 | Li_{1.0}Ni_{0.83}Co_{0.14}Al_{0.03}O_{2.0} | LiVOPO₄ | 95:5 | Graphene | Graphene | 2950 |
| | | | | (Flakes) | (Flakes) | |
| Example 2 | Li_{1.0}Ni_{0.83}Co_{0.14}Al_{0.03}O_{2.0} | LiVOPO₄ | 95:5 | CNT | CNT | 2010 |
| | | | | (Bars) | (Bars) | |
| Example 3 | Li_{1.0}Ni_{0.83}Co_{0.14}Al_{0.03}O_{2.0} | LiVOPO₄ | 95:5 | Boron | Boron | 530 |
| | | | | nitride | nitride | |
| | | | | (Flakes) | (Flakes) | |
| Example 4 | Li_{1.0}Ni_{0.83}Co_{0.14}Al_{0.03}O_{2.0} | LiVOPO₄ | 95:5 | Graphene | — | 2950 |
| | | | | (Flakes) | | |
| Comparative | Li_{1.0}Ni_{0.83}Co_{0.14}Al_{0.03}O_{2.0} | LiVOPO₄ | 95:5 | — | — | — |
| Example 1 | | | | | | |
| Comparative | Li_{1.0}Ni_{0.83}Co_{0.14}Al_{0.03}O_{2.0} | LiVOPO₄ | 95:5 | — | Graphene | 2950 |
| Example 2 | | | | | (Flakes) | |
| | | | | | IC | Capacity |
| | | | (5) | Ratio | discharge | retention |
| | | | Conductive | (1):(3): | capacity | after 100 |
| | | | auxillary | (4):(5) | [mAh/g] | cycles |
| | | Example 1 | — | 100:1.4:0.6:0 | 65 | 94% |
| | | Example 2 | — | 100:1.4:0.6:0 | 56 | 88% |
| | | Example 3 | — | 100:1.4:0.6:0 | 43 | 88% |
| | | Example 4 | — | 100:2:0:0 | 66 | 80% |
| | | Comparative | Ketjen | 100:0:0:2 | 44 | 70% |
| | | Example 1 | black | | | |
| | | | (Particles) | | | |
| | | Comparative | — | 100:0:2:0 | 38 | 75% |
| | | Example 2 | | | | |

From Table 1, it is seen that cycle characteristics are improved by forming a coating layer on the lithium nickel complex oxide surface using the high thermal conductive material with heat conductivities of 500 W/m·K or more, and/or by adding the flakes or bars of high thermal conductive material with heat conductivities of 500 W/m·K or more. The positive electrodes using graphene (flakes) exhibited better cycle characteristics than the positive electrodes using CNT (bars). Boron nitride (flakes), although inferior in thermal conduction, exhibited cycle characteristics equivalent to those of CNT (bars). These indicate that better cycle characteristics can be obtained by using flakes of high thermal conductive material than bars of high thermal conductive material.

### Examples 5 to 12 and Comparative Example 3

In Examples 5 to 12 and Comparative Example 3, battery cells were fabricated and evaluated in the same way as in Example 1 while modifying the thickness of the coating layer on the lithium nickel complex oxide surface. The thickness of the coating layer was also measured in the same way as in Example 1. The results are shown in Table 2.

TABLE 2

| | | | | (3) | (4) | | | | |
|---|---|---|---|---|---|---|---|---|---|
| | | | | Coating layer | Flakes/bars of | | Coating | IC | Capacity |
| | | (2) | | high thermal | high thermal | | layer | discharge | retention |
| | (1) | Phosphate | Ratio | conducting | conducting | Ratio | thickness | capacity | after 100 |
| | Lithium-nickel complex oxide | compound | (1):(2) | material | material | (1):(3):(4) | [nm] | [mAh/g] | cycles |
| Comparative | Li_{1.0}Ni_{0.83}Co_{0.14}Al_{0.03}O_{2.0} | LiVOPO₄ | 95:5 | — | Graphene | 100:0:0.6 | 0 | 31 | 82% |
| Example 3 | | | | | | | | | |
| Example 5 | Li_{1.0}Ni_{0.83}Co_{0.14}Al_{0.03}O_{2.0} | LiVOPO₄ | 95:5 | Graphene | Graphene | 100:0.08:0.6 | 8 | 38 | 87% |
| Example 6 | Li_{1.0}Ni_{0.83}Co_{0.14}Al_{0.03}O_{2.0} | LiVOPO₄ | 95:5 | Graphene | Graphene | 100:0.1:0.6 | 10 | 48 | 90% |
| Example 7 | Li_{1.0}Ni_{0.83}Co_{0.14}Al_{0.03}O_{2.0} | LiVOPO₄ | 95:5 | Graphene | Graphene | 100:1:0.6 | 100 | 66 | 93% |
| Example 8 | Li_{1.0}Ni_{0.83}Co_{0.14}Al_{0.03}O_{2.0} | LiVOPO₄ | 95:5 | Graphene | Graphene | 100:1.4:0.6 | 140 | 65 | 94% |
| Example 9 | Li_{1.0}Ni_{0.83}Co_{0.14}Al_{0.03}O_{2.0} | LiVOPO₄ | 95:5 | Graphene | Graphene | 100:2.5:0.6 | 200 | 63 | 94% |
| Example 10 | Li_{1.0}Ni_{0.83}Co_{0.14}Al_{0.03}O_{2.0} | LiVOPO₄ | 95:5 | Graphene | Graphene | 100:5.0:0.6 | 500 | 57 | 91% |
| Example 11 | Li_{1.0}Ni_{0.83}Co_{0.14}Al_{0.03}O_{2.0} | LiVOPO₄ | 95:5 | Graphene | Graphene | 100:5.2:0.6 | 550 | 45 | 85% |
| Example 12 | Li_{1.0}Ni_{0.83}Co_{0.14}Al_{0.03}O_{2.0} | LiVOPO₄ | 95:5 | Graphene | Graphene | 100:6.0:0.6 | 700 | 39 | 83% |

From Table 2, it is seen that high rate characteristics and cycle characteristics are exhibited when the thickness of the coating layer on the lithium nickel complex oxide surface is in the range of 10 nm to 500 nm. It will also be seen that even higher rate characteristics and cycle characteristics are exhibited when the thickness of the coating layer is in the range of 100 nm to 200 nm.

### Examples 13 to 19

In Examples 13 to 19, battery cells were fabricated and evaluated in the same way as in Example 1 while modifying the thickness of the flakes of high thermal conductive material connecting the coating layers of the lithium nickel complex oxide surfaces. The thickness of the flakes of high thermal conductive material was also measured in the same way as in Example 1. The results are shown in Table 3.

TABLE 3

| | | | | (3) | (4) | | | | |
|---|---|---|---|---|---|---|---|---|---|
| | | | | Coating layer | Flakes/bars of | | Flakes | IC | Capacity |
| | | (2) | | high thermal | high thermal | | graphene | discharge | retention |
| | (1) | Phosphate | Ratio | conducting | conducting | Ratio | thickness | capacity | after 100 |
| | Lithium-nickel complex oxide | compound | (1):(2) | material | material | (1):(3):(4) | [nm] | [mAh/g] | cycles |
| Example 13 | Li_{1.0}Ni_{0.83}Co_{0.14}Al_{0.03}O_{2.0} | LiVOPO₄ | 95:5 | Graphene | Graphene | 100:0.1:0.6 | 1 | 63 | 84% |
| Example 14 | Li_{1.0}Ni_{0.83}Co_{0.14}Al_{0.03}O_{2.0} | LiVOPO₄ | 95:5 | Graphene | Graphene | 100:0.1:0.6 | 3 | 65 | 90% |
| Example 1 | Li_{1.0}Ni_{0.83}Co_{0.14}Al_{0.03}O_{2.0} | LiVOPO₄ | 95:5 | Graphene | Graphene | 100:0.1:0.6 | 10 | 65 | 94% |
| Example 15 | Li_{1.0}Ni_{0.83}Co_{0.14}Al_{0.03}O_{2.0} | LiVOPO₄ | 95:5 | Graphene | Graphene | 100:0.1:0.6 | 40 | 66 | 93% |
| Example 16 | Li_{1.0}Ni_{0.83}Co_{0.14}Al_{0.03}O_{2.0} | LiVOPO₄ | 95:5 | Graphene | Graphene | 100:0.1:0.6 | 60 | 59 | 94% |
| Example 17 | Li_{1.0}Ni_{0.83}Co_{0.14}Al_{0.03}O_{2.0} | LiVOPO₄ | 95:5 | Graphene | Graphene | 100:0.1:0.6 | 100 | 58 | 93% |
| Example 18 | Li_{1.0}Ni_{0.83}Co_{0.14}Al_{0.03}O_{2.0} | LiVOPO₄ | 95:5 | Graphene | Graphene | 100:0.1:0.6 | 200 | 55 | 91% |
| Example 19 | Li_{1.0}Ni_{0.83}Co_{0.14}Al_{0.03}O_{2.0} | LiVOPO₄ | 95:5 | Graphene | Graphene | 100:0.1:0.6 | 300 | 55 | 91% |

From Table 3, it is seen that high rate characteristics and cycle characteristics are exhibited when the thickness of the graphene added as flakes high thermal conductive material is in the range of 3 nm to 100 nm. It is also seen that even higher rate characteristics and cycle characteristics are exhibited when the thickness of the graphene added as flakes of high thermal conductive material is in the range of 10 nm to 40 nm.

### Examples 20 to 26, Comparative Example 4

In Examples 20 to 26 and Comparative Example 4, battery cells were fabricated and evaluated in the same way as in Example 1 while modifying the ratio of lithium nickel complex oxide and phosphate compound. The results are shown in Table 4.

TABLE 4

| | | | | (3) | (4) | | | |
|---|---|---|---|---|---|---|---|---|
| | | | | Coating layer | Flakes/bars of | | IC | Capacity |
| | | (2) | | high thermal | high thermal | | discharge | retention |
| | (1) | Phosphate | Ratio | conducting | conducting | Ratio | capacity | after 100 |
| | Lithium-nickel complex oxide | compound | (1):(2) | material | material | (1):(3):(4) | [mAh/g] | cycles |
| Comparative | Li_{1.0}Ni_{0.83}Co_{0.14}Al_{0.03}O_{2.0} | LiVOPO₄ | 100:0 | Graphene | Graphene | 100:1.4:0.6 | 67 | 80% |
| Example 4 | | | | | | | | |
| Example 20 | Li_{1.0}Ni_{0.83}Co_{0.14}Al_{0.03}O_{2.0} | LiVOPO₄ | 99.5:0.5 | Graphene | Graphene | 100:1.4:0.6 | 66 | 86% |
| Example 21 | Li_{1.0}Ni_{0.83}Co_{0.14}Al_{0.03}O_{2.0} | LiVOPO₄ | 99:1 | Graphene | Graphene | 100:1.4:0.6 | 66 | 91% |
| Example 1 | Li_{1.0}Ni_{0.83}Co_{0.14}Al_{0.03}O_{2.0} | LiVOPO₄ | 95:5 | Graphene | Graphene | 100:1.4:0.6 | 65 | 94% |
| Example 22 | Li_{1.0}Ni_{0.83}Co_{0.14}Al_{0.03}O_{2.0} | LiVOPO₄ | 90:10 | Graphene | Graphene | 100:1.4:0.6 | 63 | 93% |
| Example 23 | Li_{1.0}Ni_{0.83}Co_{0.14}Al_{0.03}O_{2.0} | LiVOPO₄ | 80:20 | Graphene | Graphene | 100:1.4:0.6 | 61 | 94% |
| Example 24 | Li_{1.0}Ni_{0.83}Co_{0.14}Al_{0.03}O_{2.0} | LiVOPO₄ | 70:30 | Graphene | Graphene | 100:1.4:0.6 | 56 | 94% |
| Example 25 | Li_{1.0}Ni_{0.83}Co_{0.14}Al_{0.03}O_{2.0} | LiVOPO₄ | 60:40 | Graphene | Graphene | 100:1.4:0.6 | 53 | 92% |
| Example 26 | Li_{1.0}Ni_{0.83}Co_{0.14}Al_{0.03}O_{2.0} | LiVOPO₄ | 50:50 | Graphene | Graphene | 100:1.4:0.6 | 46 | 88% |

From Table 4, it is seen that high rate characteristics and cycle characteristics are exhibited when the ratio of phosphate compound to the positive electrode active material as a whole is in the range of 1% to 40%. It is also seen that even higher rate characteristics and cycle characteristics are exhibited when the ratio of phosphate compound to the positive electrode active material as a whole is in the range of 5% to 20%.

### Example 27, Comparative Examples 5 and 6

In Example 27 and Comparative Examples 5 and 6, battery cells were fabricated and evaluated in the same way as in Example 1 while modifying the composition of lithium nickel complex oxide. The results are shown in Table 5.

TABLE 5

| | | | | (3) | (4) | | | |
|---|---|---|---|---|---|---|---|---|
| | | | | Coating layer | Flakes/bars of | | IC | Capacity |
| | | (2) | | high thermal | high thermal | | discharge | retention |
| | (1) | Phosphate | Ratio | conducting | conducting | Ratio | capacity | after 100 |
| | Lithium-nickel complex oxide | compound | (1):(2) | material | material | (1):(3):(4) | [mAh/g] | cycles |
| Example 1 | Li_{1.0}Ni_{0.83}Co_{0.14}Al_{0.03}O_{2.0} | LiVOPO₄ | 95:5 | Graphene | Graphene | 100:1.4:0.6 | 65 | 94% |
| Example 27 | Li_{1.0}Ni_{0.8}Co_{0.1}Mn_{0.1}O_{2.0} | LiVOPO₄ | 95:5 | Graphene | Graphene | 100:1.4:0.6 | 62 | 92% |
| Comparative | Li_{1.0}Co_{1.0}O_{2.0} | LiVOPO₄ | 95:5 | Graphene | Graphene | 100:1.4:0.6 | 55 | 86% |
| Example 5 | | | | | | | | |
| Comparative | Li_{0.1}Mn_{2.0}O_{4.0} | LiVOPO₄ | 95:5 | Graphene | Graphene | 100:1.4:0.6 | 58 | 82% |
| Example 6 | | | | | | | | |

From Table 5, it is seen that the positive electrodes using lithium nickel complex oxide exhibit higher rate characteristics and cycle characteristics than the positive electrodes using lithium cobaltate or the like. It is also seen that even higher rate characteristics and cycle characteristics are exhibited when NCA represented by LiₓNi_{1-y-z}Co_{y}Al_{z}O₂ (0.05≦x≦1.2, 0<y≦0.5, 0<z≦0.5, y+z≦0.5) is used as the lithium nickel complex oxide.

### Examples 28 to 30

In Examples 28 to 30, battery cells were fabricated and evaluated in the same way as in Example 1 while modifying the phosphate compound composition. The results are shown in Table 6.

TABLE 6

| | | | | (3) | (4) | | | |
|---|---|---|---|---|---|---|---|---|
| | | | | Coating layer | Flakes/bars of | | IC | Capacity |
| | | (2) | | high thermal | high thermal | | discharge | retention |
| | (1) | Phosphate | Ratio | conducting | conducting | Ratio | capacity | after 100 |
| | Lithium-nickel complex oxide | compound | (1):(2) | material | material | (1):(3):(4) | [mAh/g] | cycles |
| Example 1 | Li_{1.0}Ni_{0.83}Co_{0.14}Al_{0.03}O_{2.0} | LiVOPO₄ | 95:5 | Graphene | Graphene | 100:1.4:0.6 | 65 | 94% |
| Example 28 | Li_{1.0}Ni_{0.83}Co_{0.14}Al_{0.03}O_{2.0} | Li₃V₂(PO₄)₃ | 95:5 | Graphene | Graphene | 100:1.4:0.6 | 66 | 93% |
| Example 29 | Li_{1.0}Ni_{0.83}Co_{0.14}Al_{0.03}O_{2.0} | LiFePO₄ | 95:5 | Graphene | Graphene | 100:1.4:0.6 | 50 | 90% |
| Example 30 | Li_{1.0}Ni_{0.83}Co_{0.14}Al_{0.03}O_{2.0} | LiMnPO₄ | 95:5 | Graphene | Graphene | 100:1.4:0.6 | 62 | 84% |

From Table 6, it is seen that high energy density and cycle characteristics are exhibited when lithium vanadium phosphate represented by LiVOPO₄ or Li₃V₂(PO₄)₃ is used as the phosphate compound.

Thus, as will be seen from the evaluation results, it has been confirmed that Examples exhibited higher rate characteristics and cycle characteristics than Comparative Examples.

The present embodiment may include the following first to tenth positive electrode active materials for lithium ion secondary battery; a first positive electrode for lithium ion secondary battery; and a first lithium ion secondary battery.

The first positive electrode active material for lithium ion secondary battery includes a lithium nickel complex oxide represented by composition formula (1) below, and a phosphate compound. At least a part of a particle surface of the lithium nickel complex oxide has a coating layer of a high thermal conductive material with heat conductivity of 500 W/m·K or more. A plurality of the coating layers are at least partially in direct contact with each other or connected with each other via flakes or bars of high thermal conductive material having heat conductivity of 500 W/m·K or more:

LiₓNi_{1-y}M_{y}O₂ (1)

where M includes at least one metal selected from the group consisting of Co, Fe, Ti, Cr, Mg, Al, Cu, Ga, Mn, Zn, Sn, B, V, Ca, and Sr, and where 0.05≦x≦1.2 and 0≦y≦0.5.

The second positive electrode active material for lithium ion secondary battery is the first positive electrode active material for lithium ion secondary battery configured such that the coating layers include portions directly in contact with each other and portions connected with each other via the flakes or bars of high thermal conductive material having heat conductivity of 500 W/m·K or more.

The third positive electrode active material for lithium ion secondary battery is the first or second positive electrode active material for lithium ion secondary battery configured such that a ratio of the phosphate compound to a total mass of the positive electrode active material for lithium ion secondary battery is 1 mass % to 40 mass %.

The fourth positive electrode active material for lithium ion secondary battery is any of the first to third positive electrode active materials for lithium ion secondary battery configured such that the coating layer has an average thickness of 10 nm to 500 nm.

The fifth positive electrode active material for lithium ion secondary battery is any of the first to fourth positive electrode active materials for lithium ion secondary battery configured such that the high thermal conductive material in the coating layer and/or the flakes or bars of high thermal conductive material connecting the coating layers at least partially include graphene or multi-layer graphene.

The sixth positive electrode active material for lithium ion secondary battery is the fifth positive electrode active material for lithium ion secondary battery configured such that the flakes or bars of high thermal conductive material connecting the coating layers at least partially are the flakes of multi-layer graphene.

The seventh positive electrode active material for lithium ion secondary battery is the fifth or sixth positive electrode active material for lithium ion secondary battery configured such that the multi-layer graphene has an average thickness of 3 nm to 100 nm.

The eighth positive electrode active material for lithium ion secondary battery is any of the first to seventh positive electrode active materials for lithium ion secondary battery configured such that the phosphate compound is a compound represented by the composition formula (2), (3), or (4):

Li₃V₂(PO₄)₃ (2)

LiNPO₄ (3)

LiₓNPO₄ (4)

where N is at least one selected from the group consisting of Mn. Co, Ni, Fe, and VO, and x is a value such that 1<x≦1.5.

The ninth positive electrode active material for lithium ion secondary battery is any of the first to eighth positive electrode active materials for lithium ion secondary battery configured such that the phosphate compound is lithium vanadium phosphate represented by LiVOPO₄ or Li₃V₂(PO₄)₃.

The tenth positive electrode active material for lithium ion secondary battery is any of the first to ninth positive electrode active materials for lithium ion secondary battery configured such that the lithium nickel complex oxide is a complex oxide represented by the following composition formula (5):

LiₓNi_{1-y-z}Co_{y}Al_{z}O₂ (5)

where x, y, and z are such that 0.05≦x≦1.2, 0<y≦0.5, 0<z≦0.5, and y+z≦0.5.

The first positive electrode for lithium ion secondary battery uses any of the first to tenth positive electrode active materials for lithium ion secondary battery.

The first lithium ion secondary battery is provided with the first positive electrode for lithium ion secondary battery, a negative electrode including a negative electrode active material, a separator disposed between the positive electrode and the negative electrode, and a non-aqueous electrolyte.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A positive electrode active material for lithium ion secondary battery, comprising:
a lithium nickel complex oxide represented by composition formula (1);
a phosphate compound; and
a coating layer formed on at least a part of a surface of a particle of the lithium nickel complex oxide, and including a high thermal conductive material with heat conductivity of 500 W/m·K or more, wherein
the coating layer of the particle of the lithium nickel complex oxide includes a portion connected to the coating layer of another particle of the lithium nickel complex oxide:
LiₓNi_{1-y}M_{y}O₂ (1)
where M includes at least one metal selected from the group consisting of Co, Fe, Ti, Cr, Mg, Al, Cu, Ga, Mn, Zn, Sn, B, V, Ca, and Sr, and x and y are such that 0.05≦x≦1.2 and 0≦y≦0.5.

2. The positive electrode active material for lithium ion secondary battery according to claim 1, wherein
the coating layer of the particle of the lithium nickel complex oxide includes a portion directly connected to the coating layer of the other particle of the lithium nickel complex oxide.

3. The positive electrode active material for lithium ion secondary battery according to claim 1, wherein
the coating layer of the particle of the lithium nickel complex oxide includes a portion connected to the coating layer of the other particle of the lithium nickel complex oxide via flakes or bars of high thermal conductive material with heat conductivity of 500 W/m·K or more.

4. The positive electrode active material for lithium ion secondary battery according to claim 2, wherein
the coating layer of the particle of the lithium nickel complex oxide includes a portion connected to the coating layer of the other particle of the lithium nickel complex oxide via flakes or bars of high thermal conductive material with heat conductivity of 500 W/m·K or more.

5. The positive electrode active material for lithium ion secondary battery according to claim 1, wherein
a ratio of the phosphate compound to a total mass of the positive electrode active material for lithium ion secondary battery is 1 mass % to 40 mass %.

6. The positive electrode active material for lithium ion secondary battery according to claim 1, wherein
the coating layer has an average thickness of 10 nm to 500 nm.

7. The positive electrode active material for lithium ion secondary battery according to claim 1, wherein
the high thermal conductive material in the coating layer includes graphene or multi-layer graphene.

8. The positive electrode active material for lithium ion secondary battery according to claim 3, wherein
the flakes or bars of high thermal conductive material include graphene or multi-layer graphene.

9. The positive electrode active material for lithium ion secondary battery according to claim 8, wherein
the flakes or bars of high thermal conductive material include flakes of the multi-layer graphene.

10. The positive electrode active material for lithium ion secondary battery according to claim 8, wherein
the multi-layer graphene has an average thickness of 3 am to 100 nm.

11. The positive electrode active material for lithium ion secondary battery according to claim 9, wherein
the multi-layer graphene has an average thickness of 3 nm to 100 nm.

12. The positive electrode active material for lithium ion secondary battery according to claim 1, wherein
the phosphate compound is a compound represented by composition formula (2), (3), or (4):
Li₃V₂(PO₄)₃ (2)
LiNPO₄ (3)
LiₓNPO₄ (4)
where N is at least one selected from the group consisting of Mn, Co, Ni, Fe, and VO, and x is a value such that 1<x≦1.5.

13. The positive electrode active material for lithium ion secondary battery according to claim 1, wherein
the phosphate compound is lithium vanadium phosphate represented by LiVOPO₄ or Li₃V₂(PO₄)₃.

14. The positive electrode active material for lithium ion secondary battery according to claim 1, wherein
the lithium nickel complex oxide is a complex oxide represented by composition formula (5):
LiₓNi_{1-y-z}Co_{y}Al_{z}O₂ (5)
where x, y, and z are such that 0.05≦x≦1.2, 0<y≦0.5, 0<z≦0.5, and y+z≦0.5.

15. A positive electrode for lithium ion secondary battery, comprising
the positive electrode active material for lithium ion secondary battery according to claim 1.

16. A lithium ion secondary battery comprising:
the positive electrode according to claim 15;
a negative electrode including a negative electrode active material;
a separator disposed between the positive electrode and the negative electrode; and
a non-aqueous electrolyte.
